(19) United States
(12) Patent Application Publication
(10) Pub. No.: US 2010/0169634 A1
(43) Pub. Date: Jul. 1, 2010

(54) SYSTEM AND METHOD FOR SELF-CLOCKING OS KERNEL BOOT

(76) Inventors: Jacob Pan, Olympia, WA (US); Vincent J. Zimmer, Federal Way, WA (US)

Correspondence Address: INTEL CORPORATION;c/o CPA Global, P.O. BOX 52050, MINNEAPOLIS, MN, 55402, US

(21) Appl. No.: 12/347,836

(22) Filed: Dec. 31, 2008

(51) Int. Cl. G06F 9/00

(52) U.S. Cl. 713/2

(57) ABSTRACT

In some embodiments, the invention involves a system and method to enable a mobile device to utilize self-clocking during boot. In at least one embodiment, a platform has at least one processor core coupled to an internal timer. For an X86 processor, the internal timer may reside in an advanced programmable interrupt controller. A boot kernel executing on the platform is configured to use the internal timer early in the boot phase, when the platform is not compliant with legacy PC/AT architecture. If the platform does conform to the legacy architecture, then the boot may use an external clock for timing and clocking early in boot. In both cases, the internal timer is calibrated to the external clock before completing the boot phase. Other embodiments are described and claimed.

### FIELD OF THE INVENTION

An embodiment of the present invention relates generally to mobile Internet devices and, more specifically, to enable a mobile device to utilize self-clocking during boot.

### BACKGROUND INFORMATION

Various mechanisms exist for booting computing devices. Most modern personal computers (PC) conform to standards for the original PC/AT. However, newer portable computing devices are smaller and use an architecture more suitable for a portable Internet capable device. Many mobile internet device (MID) platforms are being, or plan to be deployed which are based on the Intel® Atom™ processor, or similar processors. Newer low power platforms using these processors may no longer resemble the PC/AT I/O complex. Most x86 Linux and operating system (OS) distributions have built-in, a priori knowledge and expectation of this PC/AT platform capability. An X86 processor utilizes a standard instruction set architecture (ISA) but some newer platforms may not conform to the PC/AT architecture which most operating systems expect. The PC/AT platform architecture defines where the interrupt controller (e.g., Intel® family 8259 programmable interrupt controller chips), timers and counters (e.g., Intel® family 8254 programmable interval timers, and Intel® family 8255 programmable peripheral interface chips, respectively) are located on the hardware platform. Thus, these existing and powerful operating systems designed for the PC/AT architecture will not operate on the newer platforms without modification. The newer platforms also do not have a standardized hardware architecture; nor is standardization expected in the near future. Thus, customization of the Linux OS would be required for every platform.

As low power X86 processors begin to be more widespread, there is increased pressure to remove legacy devices from the smaller, portable devices. The next generation MID platform may use input/output (I/O) and system devices from third party providers. Thus, it will be desirable for the newer devices to be able to leverage the power of existing operating systems.

### BRIEF DESCRIPTION OF THE DRAWINGS

The features and advantages of the present invention will become apparent from the following detailed description of the present invention in which:

FIG. 1 is a block diagram showing exemplary architectural differences between a typical PC/AT platform and a MID platform not having traditional timers;

FIG. 2 is a block diagram of an exemplary MID platform that conforms to a non-PC/AT architecture, according to an embodiment of the invention;

FIG. 3 a flow diagram illustrating an exemplary method for selective self-clocking, according to an embodiment of the invention; and

FIG. 4 shows exemplary Linux kernel code by which a PC/AT X86 platform may be initialized.

### DETAILED DESCRIPTION

An embodiment of the present invention is a system and method relating to enabling the operating system (OS) kernel to choose the best available timing source during boot. Embodiments of the present invention span the OS kernel boot, interrupt architecture, and timing service. A known timing source must be established during OS kernel boot before kernel threading may be started. At early boot, the OS has limited ability to handle faults so it has to rely on BIOS/firmware provided platform information to initialize the timers. Even using a standard BIOS in a system, occasionally the BIOS misconfigures or misreports the timer configuration. Embodiments of the present invention obviate that platform-BIOS dependency.

Reference in the specification to “one embodiment” or “an embodiment” of the present invention means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment.

For purposes of explanation, specific configurations and details are set forth in order to provide a thorough understanding of the present invention. However, it will be apparent to one of ordinary skill in the art that embodiments of the present invention may be practiced without the specific details presented herein. Furthermore, well-known features may be omitted or simplified in order not to obscure the present invention. Various examples may be given throughout this description. These are merely descriptions of specific embodiments of the invention. The scope of the invention is not limited to the examples given.

Embodiments of the present invention enable a mobile Internet Device (MID) platform the ability to switch third party provider blocks with minimum impact to software compatibility. Embodiments of the present invention allow the OS kernel to use the local Advanced Programmable Interrupt Controller (APIC) timer for clock events. This may make the boot process more reliable and portable across X86 platforms.

In general, OS kernel timing source requires the underlying timer to be always on and have known frequency. In existing system, the local APIC timers are un-calibrated and not guaranteed to work in deep C states. However, these requirements are not necessary during boot, where the OS kernel may use an unknown frequency to drive the boot process and not enter deep C states, to allow faster booting. Embodiments of the present invention differentiate the run-time timer requirements and boot time requirements. External timers may be avoided or deferred until the OS kernel is fully up and running when more options are available for calibration (e.g. network time protocol), and timer drivers can be loaded as modules. External timers may be used after device enumeration instead of before.

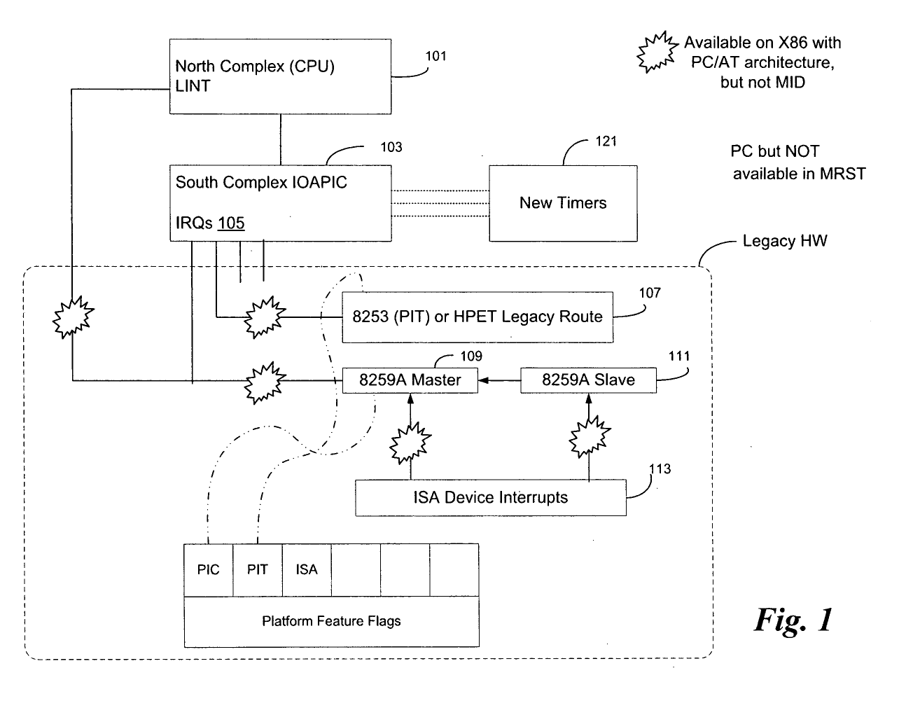

FIG. 1 is a block diagram showing exemplary architectural differences between a typical PC/AT platform and a MID platform not having traditional timers. The platform may have a North Bridge 101 coupled to a processor and having a local interrupt line (LINT). The North Bridge 101 may be coupled to a South Bridge 103 having input/output advanced programmable interrupt controllers (IOAPIC) and control lines for interrupt requests 205. The control lines may be coupled to an 8253 programmable interval timer (PIT) or high precision event timer (HPET) route timer unit 107, a master 8259A clock 109 and a slave 8259A clock 111 interrupt controller. The 8259A master and slaves (109, 111) may be coupled to an ISA device interrupt unit 113. However on MID platforms, the 825× timer or interrupt controller units may not be present to provide timing information. The Linux kernel is very rigid, and expects these components to be present during boot. Instead, a new set of timers 121 may be coupled to the South Bridge 103.

Legacy timers are external to the processor. They are used because the frequency is known and either provided by the firmware, or a hard coded value. The processor frequency may change over time, during and through post-boot. Thus, the processor timers must be calibrated with the external timers. These external timers are platform dependent. In future platforms, the external timers may vary from one device to another. Therefore boot code tied to the processor, may not be compatible with the third party timers resident on the platform. Since it can be very costly to generate a unique OS for each possible device, it is desirable to modify the OS to be platform-independent and have a self-clocking mechanism.

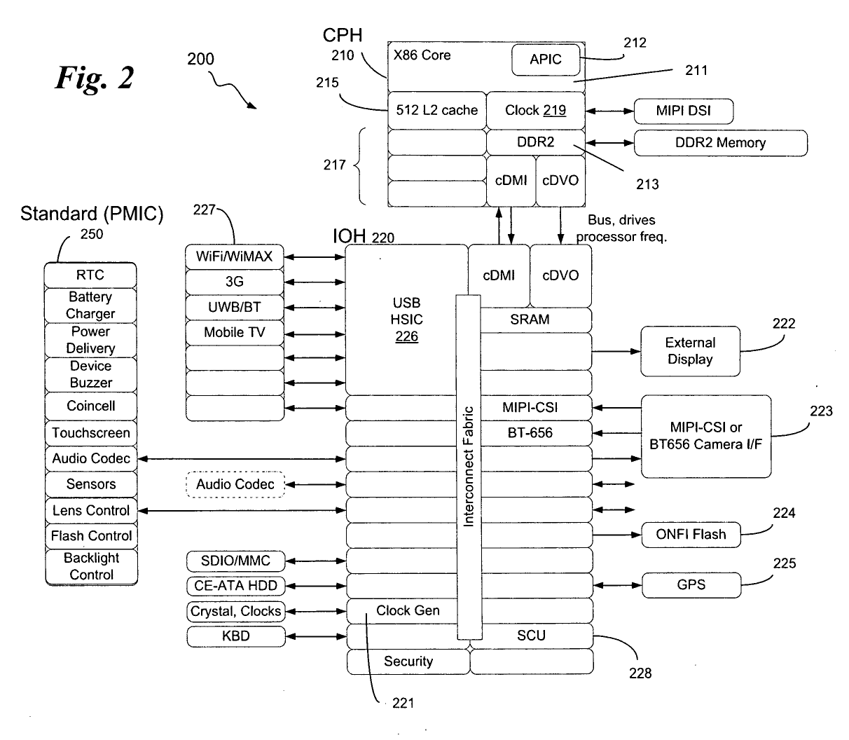

FIG. 2 is a block diagram of an exemplary MID platform that conforms to a non-PC/AT architecture, according to an embodiment of the invention. The platform 200 may comprise a central processing hub (CPH) 210 coupled to an input/output hub (IOH) 220. The CPH may be a standard X86 processor core 211 where each processor core may have its own memory controller 213 and cache 215. The CPH may have a variety of other non-processor cores, also called “uncores” 217. The X86 processor core 211 has an APIC timer 212 which may feed an X86 architecture clock 219.

The IOH 220 is an alternative architecture to existing platforms having an MCH (memory controller hub) and ICH (I/O controller hub). The IOH 220 may be coupled to a standard PMIC 250. The IOH 220 may not be PC/AT compatible. The IOH may generate timer signals with a clock generator 221. Various I/O formats and protocols may be used to interface with an external display 222, camera 223, Flash memory 224, GPS 225, etc. The IOH 220 may also have a USB controller 226 to interface with optional peripherals such as for WiFi/WiMax, 3G, Mobile TV, and other networks 227. In an embodiment, the IOH may have system controller unit (SCU) firmware 228. The SCU may be an ARC® microcontroller. In another embodiment, the IOH may have embedded microcode to perform IOAPIC emulation. The IOH 220 may also be coupled to a standard power management interface controller (PMIC) 250.

The IOH 220 clock generator 221 may be coupled to a crystal clock 220. The IOH is able to maintain the time regardless of whether the system is up or down because it receives power from the battery in the PMIC 250. The IOH may have eight (8) timers as a part of the clock generator 221.

Thus, since the CPH/IOH architecture as illustrated in FIG. 2 is not a standard PC/AT architecture, an operating system, such as the Linux kernel initialization sequence, must be made independent of the PC/AT timer hardware resources. PC/AT architecture typically uses chipset timers no longer existent in the MID architecture. Thus, the initialization sequence may be modified to use on-processor timers independent of the chipset hardware.

In an embodiment, dependency on BIOS timers is may be overcome using processor internal timers. On an X86 platform, the most available timing source is the local APIC (Advanced Programmable Interrupt Controller) timers that are inside the processor. A MID OS kernel, such as Linux, does not use these timers during boot because external timers will always be present on standardized PC/AT platforms and the local APIC timers may stop working during deep C-states and the frequency is not calibrated. However, the processor does not go to C-states during boot and the absolute frequency is not critical in the boot phase. Thus, the MID platform may use the APIC timers during boot without worrying about these two limitations.

A standard X86 PC relies on an i8254 timer, or HPET (High Precision Event Timer), to provide timing during boot. Both devices are outside CPU and may be located in an I/O controller hub (ICH), as seen in FIG. 1. A MID platform may not have an ICH as in the PC/AT architecture. Therefore, if those devices are changed in the MID platform, the X86 OS kernel must be modified to cope with the new timer as part of the critical system devices used for booting. Unlike X86 PC, a MID platform may have removed legacy devices (i8259, ISA) as well as some legacy replacement device (HPET, IOAPIC). In order to maintain binary compatibility, the kernel boot process should rely only on processor local devices such as local APIC and its timers. An Intel® Atom™ based processor may maintain those devices as part of the core X86 architecture.

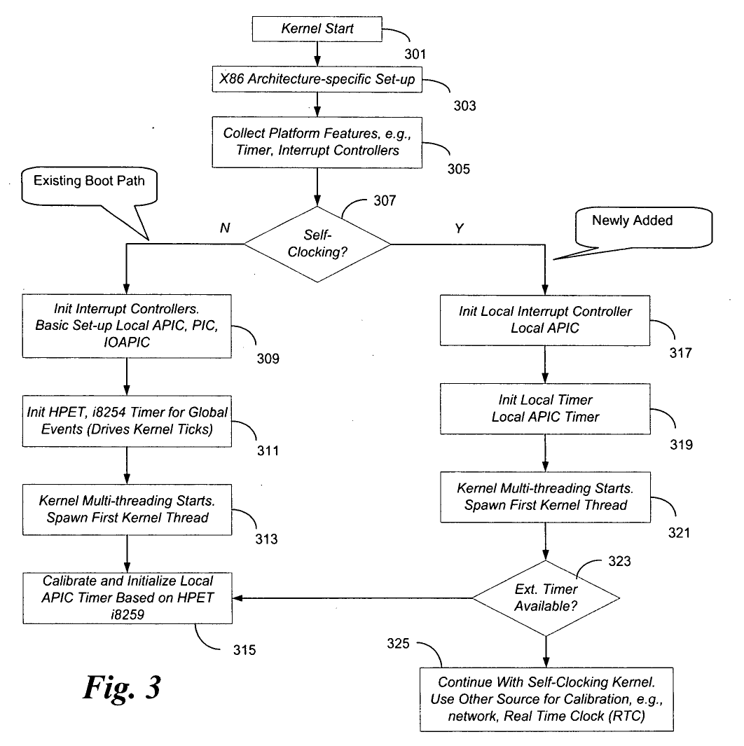

FIG. 3 is a flow diagram illustrating an exemplary method for selective self-clocking, according to an embodiment of the invention. When this exemplary method is implemented in a boot kernel, both legacy platforms and MID platforms may be booted with the same boot code. The boot kernel starts at block 301. X86 architecture-specific setup commences in block 303. Platform features, e.g., timer, interrupt controllers, etc., are collected in block 305. Two paths are shown in this exemplary method. The path on the left is typical of existing X86 systems using the PC/AT hardware architecture. The path on the right is an exemplary path using self-clocking, as described herein. When both paths are available, the kernel may be used for legacy and newer MID platforms. If the platform is not self-clocking (block 307), processing continues in block 309 where the interrupt controllers are initialized. This path is used for a platform conforming to a typical PC/AT architecture. In a standardized, legacy system, the program controller is typically an chip from the Intel® 8259 family. Local APIC, PIC and IOAPIC timers are set-up, as well. In existing systems, the IOAPIC resides on the ICH. However, in MID platforms described herein, there is no ICH with an IOAPIC, so the left path will not work for the MID platform. However, some MID platforms in the future may use the system controller unit (SCU) firmware or microcode to emulate the IOAPIC. In existing PC/AT platforms, the Intel® 8254 Programmable Interval Timer (PIT), or the high precision event timer (HPET), which was meant to supplement and replace the i8254 PIT and the Real-time clock's (RTC) periodic interrupt function, are initialized in block 311. More information of the HPET and PIT may be found at en*wikipedia*org/wiki/HPET and en*wikipedia*org/wiki/Programmable_Interval_Timer, respectively. The HPET and PIT are external timers used for global events, i.e., drive timer ticks etc. Kernel multi-threading starts in block 313, and the first kernel thread may be spawned. The local APIC timer based on HPET is calibrated and initialized in block 315.

When self-clocking is implemented, as determined in block 307, a local interrupt controller, e.g., in the local APIC, is initialized in block 317. This method is not used in existing PC/AT platforms because external timers arc well defined and more reliable than using a local timer. Therefore all Linux boot code, for instance, will initialize using the external timers first and then calibrate to the local timer in the processor core. However, emerging MID platform architecture does not allow for this method because the hardware is different and the external timers do not exist, and third party timer hardware may vary by platform. Thus, this type of architecture would require custom boot code, for each individual platform. Therefore, a self-clocking method is described herein to allow for the Linux boot, for instance, to be modified to use self-clocking so that custom code is not required for each platform type. The local timer, i.e., local APIC timer, residing in the processing core, is initialized in block 319. The kernel multi-threading starts in block 321 and the first kernel thread may be spawned. If an external timer is available in the platform, as determined in block 323, processing will continue at block 315 to calibrate and initialize the external timer. Otherwise, processing continues with the self-clocking kernel at block 325. In this case, other sources may be used for calibration, such as a network or real time clock (RTC), for instance in the PMIC 250 (FIG. 2). The timers within the IOH may be used for calibration, as well, if they are set to fixed frequencies. Regardless, the MID platform will use the internal APIC timers as long as possible during boot and delay calibration with external timers as long as possible. The later in the boot process, the more choices

As shown in FIG. 3, the initialization of the external timers are avoided during boot if the self-clocking path is chosen. The un-calibrated local timer is sufficient for booting, but wall clock is still needed to drive the full service provided by the OS. The calibration may be done at a much later time where more kernel services are established at a point when the kernel is fully running with better fault handling capabilities and network access.

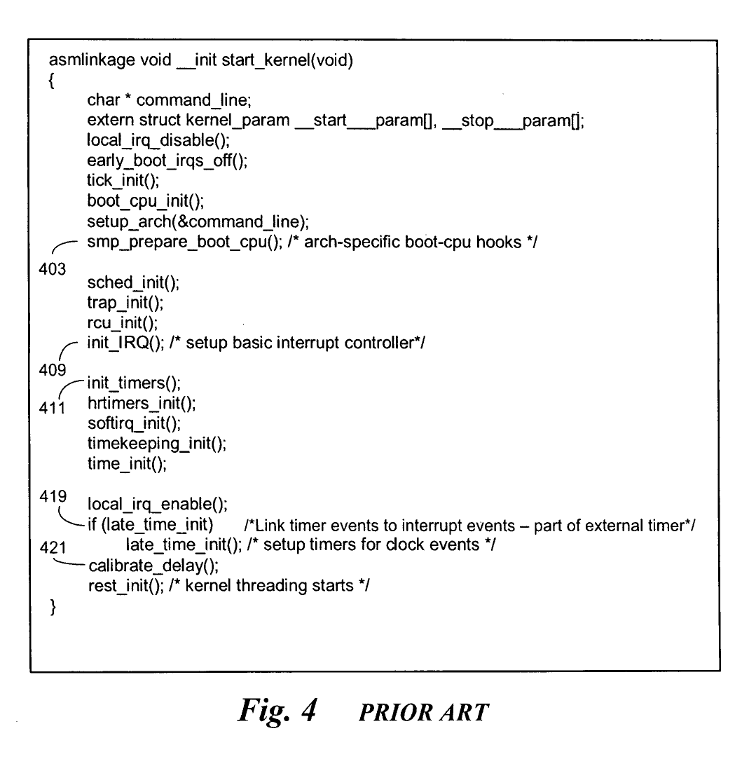

FIG. 4 shows exemplary Linux kernel code by which a PC/AT X86 platform may be initialized. For instance, architecture-specific boot processor hooks are executed at 403, corresponding to block 303, FIG. 3. The basic interrupt controller is setup at 409, corresponding to block 309, FIG. 3. Timers are initialized at 411, corresponding to block 311, FIG. 3. Timer events are linked to interrupt events as part of the external timer, at 419, corresponding to block 311, FIG. 3. The timers are calibrated at 421, corresponding to block 315, FIG. 3. It will be apparent to one of skill in the art how to modify the kernel to include the method as described herein.

The techniques described herein are not limited to any particular hardware or software configuration; they may find applicability in any computing, consumer electronics, or processing environment. The techniques may be implemented in hardware, software, or a combination of the two.

For simulations, program code may represent hardware using a hardware description language or another functional description language which essentially provides a model of how designed hardware is expected to perform. Program code may be assembly or machine language, or data that may be compiled and/or interpreted. Furthermore, it is common in the art to speak of software, in one form or another as taking an action or causing a result. Such expressions are merely a shorthand way of stating execution of program code by a processing system which causes a processor to perform an action or produce a result.

Each program may be implemented in a high level procedural or object-oriented programming language to communicate with a processing system. However, programs may be implemented in assembly or machine language, if desired. In any case, the language may be compiled or interpreted.

Program instructions may be used to cause a general-purpose or special-purpose processing system that is programmed with the instructions to perform the operations described herein. Alternatively, the operations may be performed by specific hardware components that contain hardwired logic for performing the operations, or by any combination of programmed computer components and custom hardware components. The methods described herein may be provided as a computer program product that may include a machine accessible medium having stored thereon instructions that may be used to program a processing system or other electronic device to perform the methods.

Program code, or instructions, may be stored in, for example, volatile and/or non-volatile memory, such as storage devices and/or an associated machine readable or machine accessible medium including solid-state memory, hard-drives, floppy-disks, optical storage, tapes, flash memory, memory sticks, digital video disks, digital versatile discs (DVDs), etc., as well as more exotic mediums such as machine-accessible biological state preserving storage. A machine readable medium may include any mechanism for storing, transmitting, or receiving information in a form readable by a machine, and the medium may include a tangible medium through which electrical, optical, acoustical or other form of propagated signals or carrier wave encoding the program code may pass, such as antennas, optical fibers, communications interfaces, etc. Program code may be transmitted in the form of packets, serial data, parallel data, propagated signals, etc., and may be used in a compressed or encrypted format.

Program code may be implemented in programs executing on programmable machines such as mobile or stationary computers, personal digital assistants, set top boxes, cellular telephones and pagers, consumer electronics devices (including DVD players, personal video recorders, personal video players, satellite receivers, stereo receivers, cable TV receivers), and other electronic devices, each including a processor, volatile and/or non-volatile memory readable by the processor, at least one input device and/or one or more output devices. Program code may be applied to the data entered using the input device to perform the described embodiments and to generate output information. The output information may be applied to one or more output devices. One of ordinary skill in the art may appreciate that embodiments of the disclosed subject matter can be practiced with various computer system configurations, including multiprocessor or multiple-core processor systems, minicomputers, mainframe computers, as well as pervasive or miniature computers or processors that may be embedded into virtually any device. Embodiments of the disclosed subject matter can also be practiced in distributed computing environments where tasks or portions thereof may be performed by remote processing devices that are linked through a communications network.

Although operations may be described as a sequential process, some of the operations may in fact be performed in parallel, concurrently, and/or in a distributed environment, and with program code stored locally and/or remotely for access by single or multi-processor machines. In addition, in some embodiments the order of operations may be rearranged without departing from the spirit of the disclosed subject matter. Program code may be used by or in conjunction with embedded controllers.

While this invention has been described with reference to illustrative embodiments, this description is not intended to be construed in a limiting sense. Various modifications of the illustrative embodiments, as well as other embodiments of the invention, which are apparent to persons skilled in the art to which the invention pertains are deemed to lie within the spirit and scope of the invention.

What is claimed is:

1. A system utilizing self-clocking, comprising:
a platform comprising a central processing hub for processing instructions on the platform, an input/output hub to communicate with peripheral devices, a power management interface to provide power to the platform;
the central processing hub further comprising: a processor core, the processor core having associated memory and an internal clocking unit;
the processor core communicatively coupled to at least one external timer unit; and
a boot kernel to execute on the processor core, wherein the boot kernel is configured to utilize the internal timer unit for timing and clocking events during platform boot, and wherein the boot kernel is further configured to calibrate the internal timer unit with the at least one external clocking unit late in the boot phase.

2. The system as recited in claim 1, wherein the internal clocking unit resides in an advanced programmable interrupt controller within the processor core.

3. The system as recited in claim 2, wherein the processor core comprises an X86 processor.

4. The system as recited in claim 1, wherein the boot kernel comprises a Linux operating system boot kernel.

5. The system as recited in claim 1, wherein the platform comprises a plurality of processor cores.

6. The system as recited in claim 1, wherein the platform comprises a low power mobile Internet device.

7. The system as recited in claim 1, wherein the boot kernel is configured to boot a legacy platform using the at least one external timer unit during early boot, and is also configured to use the internal clocking unit during early boot for a low powered mobile Internet device having a non-PC/AT architecture.

8. A method for self-clocking in a platform, comprising:
booting the platform having a processor core coupled to an internal clocking unit, wherein the platform is coupled to at least one external timer unit;
using the internal clocking unit for timing and clocking events early in a boot phase of booting the platform; and
calibrating the internal clocking unit with the at least one external timer unit, the calibrating being performed late in the boot phase.

9. The method as recited in claim 8, wherein the internal clocking unit resides in an advanced programmable interrupt controller.

10. The method as recited in claim 9, wherein the processor core comprises an X86 processor.

11. The method as recited in claim 8, wherein the booting is performed by a boot kernel executing on the processor core.

12. The method as recited in claim 11, wherein the boot kernel comprises a Linux kernel.

13. The method as recited in claim 8, wherein the platform comprises a low power mobile Internet device.

14. The method as recited in claim 8, further comprising:
determining whether the platform conforms to a PC/AT architecture; and
when the platform conforms to a PC/AT architecture, then using the at least one external timer unit for timer and clocking events early in the boot phase, and when the platform does not conform to a PC/AT architecture, then using the internal clocking unit for timer and clocking events early in the boot phase.

15. A computer readable storage medium having instructions stored therein for self-clocking in a platform, the instructions when executed on the platform causing the platform to:
boot the platform having a processor core coupled to an internal clocking unit, wherein the platform is coupled to at least one external timer unit;
use the internal clocking unit for timing and clocking events early in a boot phase of booting the platform; and
calibrate the internal clocking unit with the at least one external timer unit, the calibrating being performed late in the boot phase.

16. The medium as recited in claim 15, wherein the internal clocking unit resides in an advanced programmable interrupt controller.

17. The medium as recited in claim 16, wherein the processor core comprises an X86 processor.

18. The medium as recited in claim 15, wherein the booting is performed by boot kernel instructions executing on the processor core.

19. The medium as recited in claim 18, wherein the boot kernel instructions comprise a Linux kernel.

20. The medium as recited in claim 15, wherein the platform comprises a low power mobile Internet device.

21. The medium as recited in claim 15, further comprising instructions to:
determine whether the platform conforms to a PC/AT architecture; and
when the platform conforms to a PC/AT architecture, then use the at least one external timer unit for timer and clocking events early in the boot phase, and when the platform does not conform to a PC/AT architecture, then use the internal clocking unit for timer and clocking events early in the boot phase.
